(19) United States
(12) Patent Application Publication
(10) Pub. No.: US 2008/0185191 A1
(43) Pub. Date: Aug. 7, 2008

(54) ELECTRONIC PRODUCT AND TOUCHPAD STRUCTURE THEREOF AND METHOD FOR FORMING THE SAME

(75) Inventor: Chih-Nan Lin, Yunlin County (TW)

Correspondence Address: QUINTERO LAW OFFICE, PC, 2210 MAIN STREET, SUITE 200, SANTA MONICA, CA, 90405, US

(73) Assignee: DARFON ELECTRONICS CORP., TAOYUAN (TW)

(21) Appl. No.: 12/023,862

(22) Filed: Jan. 31, 2008

(30) Foreign Application Priority Data
Feb. 2, 2007 (TW) TW96103848

(51) Int. Cl. G06F 3/041

(52) U.S. Cl. 178/18.03

(57) ABSTRACT

A touchpad comprises a first insulating layer and a second insulating layer. The first insulating layer has a sensor surface and a plurality of metal sensors disposed on the sensor surface. The second insulating layer has a touch surface and a connecting surface. The connecting surface is opposite to the touch surface and covers the metal sensors. An electronic product comprises a main body and a touchpad. The main body has an exterior. The touchpad is disposed in the main body and exposed to the exterior of the main body. A method for forming a touchpad comprises locating a plurality of metal sensors on a sensor surface of a first insulating layer, and then connecting the first insulating layer and a second insulating layer, with the metal sensors sandwiched between the first insulating layer and the second insulating layer.

### BACKGROUND OF THE INVENTION

1. Field of the Invention

The invention relates to an electronic product, a touchpad thereof and a method for forming the touchpad, and more particularly to a touchpad with a first insulating layer and a second insulating layer.

2. Description of the Related Art

Various types of high-tech products have gradually become popularized, such as notebook computers, personal digital assistants, global positioning systems and digital cameras. Driven by consumer demand, multi-functional miniaturized high-tech products have been developed. The current high-tech product consumer trend is for smaller and lighter products, with simplified functions facilitating longer portable usage.

Generally touchpads can be divided into four types, such as a resistance-type, electric capacity-type, sound wave-type and optics-type. The most common and widely used type is the electric capacity-type touchpad. An electric capacity-type touchpad, is a kind of input device which uses the finger to slide on a smooth touchpad surface to operate and move a cursor. The electric capacity-type touchpads are thin enough to meet miniaturized high-tech products requirements, by replacing other devices such as a keyboard and mouse for portability and convenience. Furthermore, because the touchpad is not mechanical-type, maintenance is relatively convenient.

A conventional electric capacity-type touchpad 10 comprises a circuit board 101, a sensor surface 102, a plurality of metal sensors 103, a mylar film (MyLar) 104, an electronic component 105, adhesives 106, and a touchpad 107. A plurality of metal sensors 103 is disposed on the circuit board 101. The mylar film 104 is bonded to the circuit board 101 by the adhesives 106. When a user touches the mylar film 104 of the touchpad 107, capacitance of the metal sensors 103 are changed. Then, a signal is transferred to the electronic component 105 though the sensor surface 102, and the electronic component 105 detect variations of capacitance for transferring the capacitance into coordinates.

The main process method for manufacturing a conventional electric capacity-type touchpad is by bounding, wherein the mylar film and the circuit board are bonded by adhesives, with the metal sensors fixed therebetween. Such a process, however, does not meet requirements for reducing costs and process steps.

### BRIEF SUMMARY OF THE INVENTION

A detailed description is given in the following embodiments with reference to the accompanying drawings.

The invention provides a touchpad comprising a first insulating layer and a second insulating layer. The first insulating layer has a sensor surface and a plurality of metal sensors disposed on the sensor surface. The second insulating layer has a touch surface and a connecting surface. The connecting surface is opposite to the touch surface and covers the metal sensors.

The first insulating layer and the second insulating layer are connected by laminating.

The invention provides another touchpad comprising a first circuit board and a second circuit board. The first circuit board has a sensor surface and a plurality of metal sensors disposed on the sensor surface. The second circuit board has a touch surface and a connecting surface. The connecting surface is opposite to the touch surface and covers the metal sensors.

The invention provides another electronic product comprising a main body and a touchpad. The main body has an exterior. The touchpad is disposed in the main body and exposed to the exterior of the main body.

The electronic product comprises a notebook computer, a personal digital assistant, a global positioning system or a digital camera.

The invention provides a method for forming a touchpad comprising locating a plurality of metal sensors on a sensor surface of a first insulating layer, and then connecting the first insulating layer and a second insulating layer, with the metal sensors sandwiched between the first insulating layer and the second insulating layer.

The metal sensors are formed on the sensor surface by etching.

The first insulating layer and the second insulating layer are connected by laminating.

The capacitor of a conventional touchpad is formed by a mylar film, and then the mylar film and a circuit board are bonded by adhesives in the assembly factory to complete the conventional touchpad. The capacitor of the touchpad of the invention is formed by laminating two insulating layers, wherein the insulating layers replace the mylar film of the conventional technique. For the manufacturing process of the insulating layer of the invention, the first insulating layer and the second insulating layer may be manufactured in one factory and the manufacturing technique used is a simply procedure. Therefore, allowing the first insulating layer of the touchpad of the invention to replace the mylar film and adhesives of the conventional touchpad, saving costs of the mylar film and adhesives. Additionally, manufacturing process is simplified as the mylar film and adhesives are omitted. Thus, overall costs are lowered and processing procedures are simplified, raising manufacturing process efficiency.

### BRIEF DESCRIPTION OF THE DRAWINGS

The invention can be more fully understood by reading the subsequent detailed description and examples with references made to the accompanying drawings, wherein:

FIG. 1 is a sectional view of a conventional touchpad.

FIG. 2 is a sectional view of a touchpad in accordance with a first embodiment of the invention.

FIG. 3 is a sectional view of a touchpad in accordance with a second embodiment of the invention.

FIG. 4 is a schematic view of a main body of an electronic product.

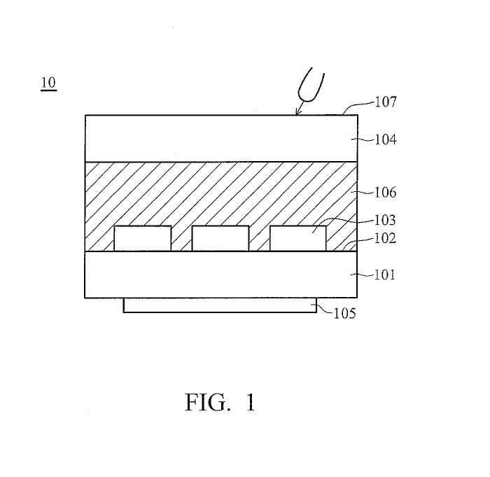

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Referring to FIG. 2, a sectional view of a touchpad in accordance with a first embodiment of the invention is shown. The touchpad 30 comprises a first insulating layer 301 and a second insulating layer 305. The first insulating layer 301 has a sensor surface 303 and a plurality of metal sensors 304 disposed on the sensor surface 303. The second insulating layer 305 has a touch surface 306 and a connecting surface 307, wherein the connecting surface 307 is opposite to the touch surface 306 and covers the metal sensors 304. The first insulating layer 301 and the second insulating layer 305 are connected by laminating.

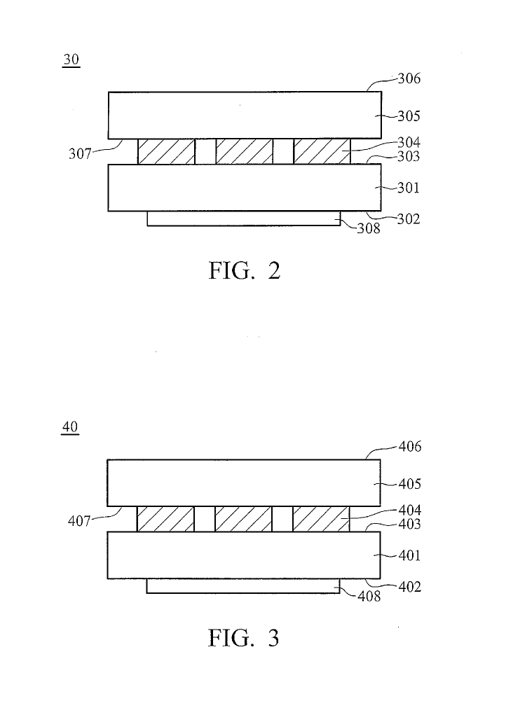

Referring to FIG. 3, a sectional view of a touchpad in accordance with a second embodiment of the invention is shown. The touchpad 40 comprises a first circuit board 401 and a second circuit board 405. The first circuit board 401 has a sensor surface 403 and a plurality of metal sensors 404 disposed on the sensor surface 403. The second circuit board 405 has a touch surface 406 and a connecting surface 407, wherein the connecting surface 407 is opposite to the touch surface 406 and covers the metal sensors 404. The first circuit board 401 and the second circuit board 405 are connected by laminating.

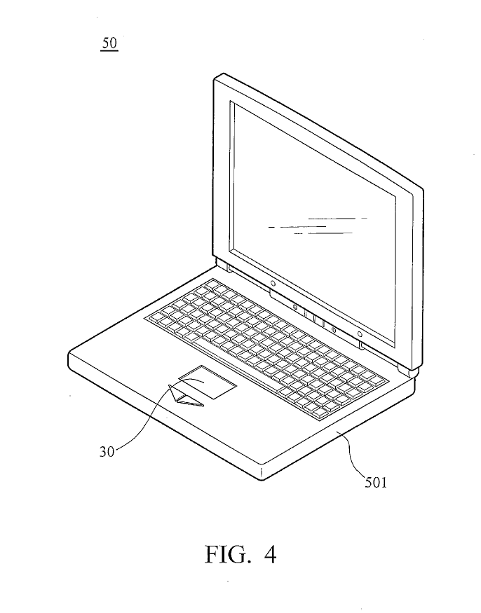

Referring to FIG. 4, an electronic product 50 of the invention is a notebook, a personal digital assistant (PDA), a global positioning system (GPS) or a digital camera. The electronic product 50 comprises a main body 501 and a touchpad 30. The main body 501 has an exterior. The touchpad 30 is disposed in the main body 501 and exposed to the exterior of the main body 501.

The method for forming the touchpad of the invention is described in detail in the following. A plurality of metal sensors is located on the sensor surface of the first insulating layer, and the metal sensors are formed on the sensor surface by etching. Then, the first insulating layer and the second insulating layer are connected by laminating, and the metal sensors are sandwiched between the first insulating layer and the second insulating layer to complete the touchpad of the invention.

From the above description, it is understood that processing costs of the touchpad of the invention can be reduced. Also, the invention does not require an additional step of assembling the touchpad. Thus, overall costs are lowered and processing procedures are simplified, raising manufacturing process efficiency.

While the invention has been described by way of example and in terms of preferred embodiment, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A touchpad comprising:
a first insulating layer having a sensor surface and a plurality of metal sensors disposed on the sensor surface; and
a second insulating layer having a touch surface and a connecting surface,
wherein the connecting surface is opposite to the touch surface and covers the metal sensors.

2. The touchpad as claimed in claim 1, wherein the first insulating layer and the second insulating layer are connected by laminating.

3. An touchpad comprising:
a first circuit board having a sensor surface and a plurality of metal sensors disposed on the sensor surface; and
a second circuit board having a touch surface and a connecting surface,
wherein the connecting surface is opposite to the touch surface and covers the metal sensors.

4. An electronic product comprising:
a main body having an exterior; and
a touchpad as claimed in claim 1, disposed in the main body and exposed to the exterior of the main body.

5. The electronic product as claimed in claim 4, wherein the electronic product comprises a notebook, a personal digital assistant, a global positioning system or a digital camera.

6. A method for forming a touchpad comprising:
locating a plurality of metal sensors on a sensor surface of a first insulating layer; and
connecting the first insulating layer and a second insulating layer, with the metal sensors sandwiched between the first insulating layer and the second insulating layer.

7. The method for forming the touchpad as claimed in claim 6, wherein the metal sensors are formed on the sensor surface by etching.

8. The method for forming the touchpad as claimed in claim 6, wherein the first insulating layer and the second insulating layer are connected by laminating.

9. A method for forming a touchpad comprising:
locating a plurality of metal sensors on a sensor surface of a first circuit board; and
connecting the first circuit board and a second circuit board, with the metal sensors sandwiched between the first circuit board and the second circuit board.

10. The method for forming the touchpad as claimed in claim 9, wherein the metal sensors are formed on the sensor surface by etching.

11. The method for forming the touchpad as claimed in claim 9, the first circuit board and the second circuit board are connected by laminating.
